(19) United States
(12) Patent Application Publication
(10) Pub. No.: US 2026/0034738 A1
(43) Pub. Date: Feb. 5, 2026

(54) RESPONSIVE TOOLPATH OPTIMIZATION SYSTEM FOR ADDITIVE MANUFACTURING MACHINE

(71) Applicant: OptiFab Technologies, Kitchener (CA)

(72) Inventors: Esmaeil SADEGHI, Kitchener (CA); Paria KARIMI, Kitchener (CA)

(21) Appl. No.: 18/789,775

(22) Filed: Jul. 31, 2024

(51) Int. Cl. B29C 64/393; B29C 64/135; B33Y 50/02; H04N 5/33

(52) U.S. Cl. CPC B29C 64/393; B29C 64/135; B33Y 50/02; H04N 5/33

(57) ABSTRACT

The present disclosure provides a dynamic toolpath optimization system for an additive manufacturing machine. The system comprises an input reception unit to receive user-provided information comprising three-dimensional (3D) geometric design data of an object and material composition details; a design analysis component utilizing a first artificial intelligence technique to determine an effective toolpath for each layer; a monitoring unit that monitors quality control metrics and current manufacturing conditions and a machine learning analysis unit that accesses a historical database to generate one or more artificial intelligence (AI) models. The system further comprises a toolpath optimization unit utilizes the generated AI models to process monitored quality control metrics and current manufacturing conditions to identify flaws and determine a toolpath optimization strategy and a control unit dynamically regulates the additive manufacturing machine based on the determined toolpath optimization strategy.

### FIELD OF THE INVENTION

Generally, the present disclosure relates to manufacturing systems. Particularly, the present disclosure relates to a toolpath optimization system for additive manufacturing machines.

### BACKGROUND

Additive manufacturing has gained significant traction across various industries due to the capability thereof to produce complex geometric designs with high precision. The process involves layer-by-layer material deposition to create an object based on digital 3D design data. Such a technique is utilized in producing prototypes, manufacturing components and even in end-use production across sectors like aerospace, automotive, healthcare and consumer goods.

However, despite having various advantages, additive manufacturing processes face several challenges. For example, a notable challenge is the optimization of toolpaths to ensure the efficiency and quality of the produced object. The toolpath refers to the route taken by the print head or nozzle during the layer-by-layer construction of an object. The precision of toolpaths significantly impacts the structural integrity, surface finish and overall quality of the manufactured object. Conventional methods for toolpath planning are often inadequate in handling complex geometries and varying material compositions, leading to defects and suboptimal performance of the additive manufacturing machine. Uniform heat distribution is a key challenge of current toolpaths generation techniques, thereby balancing heat with smart toolpaths to ensure uniform heat distribution across the printed parts is utmost need.

Further, current state-of-the-art systems utilize basic algorithms and heuristics for toolpath generation. Such methods often fail to account for the dynamic nature of the manufacturing process and do not incorporate real-time adjustments based on ongoing production conditions. For instance, traditional systems do not adequately monitor or adjust quality control metrics during the manufacturing process, resulting in defects that are only identified post-production. Consequently, there is a significant waste of materials and time, and the need for post-processing increases.

Moreover, existing systems lack advanced analysis capabilities to identify presence of hot and cold spots with the material during manufacturing of the object. As a result, such systems struggle with effectively optimizing the toolpath for different layers of the object, especially when dealing with intricate designs or varying material properties in light of presence of the hot and/or cold spots.

Another example of a known method involves the use of predefined templates and manual adjustments by the operator to control the toolpath. Such an approach is labor-intensive and prone to human error. The absence of automation and intelligent feedback mechanisms in these systems limits their scalability and efficiency. Furthermore, the inability to dynamically adapt to current manufacturing conditions often leads to inconsistencies in the quality of the produced objects.

Other state-of-the-art systems are associated with similar drawbacks, including limited adaptability to different types of materials, inadequate defect detection mechanisms and insufficient control over the additive manufacturing machine during the production process. These problems collectively highlight the need for a more sophisticated and intelligent approach to toolpath optimization in additive manufacturing.

In light of the above discussion, there exists an urgent need for solutions that overcome the problems associated with conventional systems and/or techniques for toolpath optimization in additive manufacturing machines.

### SUMMARY

In an aspect, the present disclosure provides a toolpath optimization system for an additive manufacturing machine. The system comprises an input reception unit to receive user-provided information. The user-provided information comprises three-dimensional (3D) geometric design data of an object to be manufactured using the additive manufacturing machine and material composition details and a design analysis component connected to the input reception unit. The design analysis component utilizes a first artificial intelligence technique to examine the user-provided information to determine an effective toolpath for manufacturing each layer of the object. The system further comprises a monitoring unit that monitors quality control metrics of each layer and current manufacturing conditions as well as a machine learning analysis unit that accesses a historical database to generate one or more artificial intelligence (AI) models. The historical database comprises multiple prestored 3D shapes of multiple articles and wherein each 3D shape is indexed, individually, with each of optimal toolpath settings, substance details, recorded printing parameters, identified defect and modification executed to the optimized toolpath settings to resolve the identified defect. Moreover, the system comprises a toolpath optimization unit that utilizes the generated one or more AI models to process the monitored quality control metrics and the current manufacturing conditions to identify one or more flaws and determine a toolpath optimization strategy to mitigate each identified flaw and a control unit dynamically regulates the additive manufacturing machine based on the determined toolpath optimization strategy. The system enables enhanced precision and efficiency in the manufacturing process, resulting in high-quality output with minimal defects. The control unit dynamically adjusts toolpath parameters to manage heat distribution throughout the printing process, preventing the formation of hot spots or cold spots which could compromise print quality.

In an embodiment, the input reception unit comprises a data interface port to connect with external CAD tools and wherein the data interface port facilitates direct import of the 3D geometric design data and material composition details from the external CAD tools into the system. The system enables seamless integration with external CAD tools, enhancing the ease of use and reducing the time required for data input.

In an embodiment, the monitoring unit comprises a high-resolution camera array to capture detailed images of each layer. The high-resolution camera array is connected to the control unit for real-time analysis of the quality control metrics using the captured images.

In an embodiment, the monitoring unit comprises multiple environmental sensors to measure the current manufacturing conditions. The current manufacturing conditions comprise temperature, oxygen level, humidity and vibration. The environmental sensors are networked to provide comprehensive data for analysis. The system enables detailed real-time monitoring and analysis of manufacturing conditions, enhancing the accuracy and reliability of the quality control process.

In an embodiment, the high-resolution camera array comprises a thermal imaging camera to capture temperature distribution data across each layer and wherein the thermal imaging camera is mounted on an adjustable arm. The system enables precise thermal analysis of each layer, contributing to better defect detection and correction.

In an embodiment, the toolpath optimization unit includes an actuator mechanism to implement the toolpath optimization strategy. The actuator mechanism is connected to the control unit for real-time adjustments to the manufacturing. The system enables dynamic and precise adjustments to the manufacturing process, ensuring optimal toolpath execution.

In an embodiment, the system comprises a multi-axis motion control unit to regulate movements of the additive manufacturing machine. The multi-axis motion control unit is connected to the control unit. The control unit synchronizes the multi-axis motion control unit with the toolpath optimization unit to ensure precise execution of the optimized toolpath. The system enables precise multi-axis control, enhancing the accuracy of the manufacturing process.

In an embodiment, the monitoring unit comprises a laser scanner to measure surface topography of each printed layer and wherein the laser scanner is mounted on a motorized track. The system enables precise topographical analysis of printed layers, contributing to improved quality control.

In an embodiment, the toolpath optimization unit comprises a calibration arrangement to adjust the manufacturing based on the identified flaws. The calibration mechanism is connected to the control unit for automated fine-tuning of the additive manufacturing machine. The system enables automated fine-tuning, enhancing the overall efficiency and quality of the manufacturing process.

### BRIEF DESCRIPTION OF THE DRAWINGS

The features and advantages of the present disclosure would be more clearly understood from the following description taken in conjunction with the accompanying drawings in which:

FIG. 1 shows a schematic illustration of a toolpath optimization system, in accordance with an embodiment of the present disclosure;

FIG. 2 shows a block diagram of the system of FIG. 1, in accordance with an embodiment of the present disclosure;

FIG. 3 shows a flowchart of a method of optimizing toolpath for an additive manufacturing machine, in accordance with an embodiment of the present disclosure; and

FIG. 4 shows a sequence diagram of the method of optimizing toolpath of FIG. 3, in accordance with an embodiment of the present disclosure.

### DETAILED DESCRIPTION

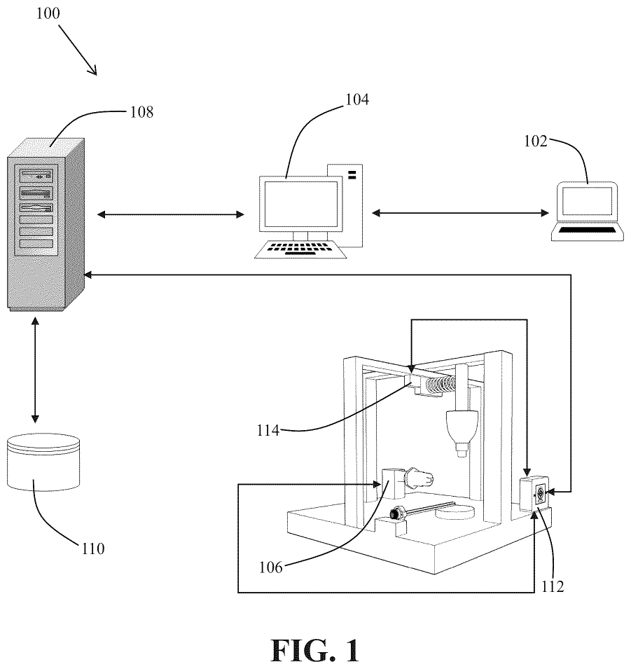

Referring to FIG. 1, there is shown a schematic illustration of a toolpath optimization system 100, in accordance with an embodiment of the present disclosure.

As used herein, the term “system” refers to an arrangement comprising multiple interconnected components structured to work together to achieve a specific purpose, in said disclosure, generating a toolpath for an additive manufacturing device. The structure of said system involves the integration of various components through data communication and control interfaces to produce high-quality printed objects. The system interacts with various modules, each performing specific functions which contribute to the overall efficiency and accuracy of the additive manufacturing process.

The term “toolpath optimization system” as used throughout the present disclosure relates to a system to optimize the path followed by the additive manufacturing machine to fabricate an object.

The term “input reception unit” as used throughout the present disclosure relates to a unit that receives user-provided information. The input reception unit receives user-provided information, which comprises three-dimensional (3D) geometric design data of an object to be manufactured using the additive manufacturing machine and material composition details.

The term “design analysis component” as used throughout the present disclosure relates to a component connected to the input reception unit to examine the user-provided information. The design analysis component utilizes a first artificial intelligence technique to determine an effective toolpath for manufacturing each layer of the object. The design analysis component enables accurate examination of the 3D geometric design data and material composition details to optimize the toolpath for each layer of the object. The design analysis component comprises algorithms and processing capabilities to analyze complex patterns and material data.

The term “t” as used throughout the present disclosure relates to a unit that monitors quality control metrics of each layer and current manufacturing conditions. The monitoring unit enables continuous observation of the manufacturing process to ensure the quality of each layer and adapt to real-time manufacturing conditions. The monitoring unit detects near real-time or real-time printing conditions, for example temperature, layer thickness, and material deposition accuracy. The monitoring device provides feedback to the responsive pattern selection module to optimize the toolpath. The monitoring device comprises sensors and data processing units to monitor various aspects of the printing process. The monitoring device enables accurate and timely feedback, improving print quality and consistency.

The term “machine learning analysis unit” as used throughout the present disclosure relates to a unit that accesses a historical database to generate one or more artificial intelligence models. The historical database comprises multiple prestored 3D shapes of multiple articles, with each 3D shape indexed individually with optimal toolpath settings, substance details, recorded printing parameters, identified defects and modifications executed to the optimized toolpath settings to resolve the identified defects. The machine learning analysis unit enables the generation of AI models by utilizing historical data, facilitating improved toolpath optimization strategies.

The term “toolpath optimization unit” as used throughout the present disclosure relates to a unit that utilizes the generated AI models to process the monitored quality control metrics and current manufacturing conditions. The toolpath optimization unit identifies one or more flaws and determines a toolpath optimization strategy to mitigate each identified flaw. The toolpath optimization unit enables the dynamic adaptation of the toolpath based on real-time data, ensuring improved manufacturing quality.

The term “control unit” as used throughout the present disclosure relates to a unit that responsively regulates the additive manufacturing machine based on the determined toolpath optimization strategy. The control unit enables the implementation of optimized toolpath strategies to regulate the manufacturing machine, ensuring the production of high-quality objects. The control unit responsively adjusts toolpath parameters to enable even heat distribution throughout the printing process to prevent the formation of hot or cold spots, enabling consistent material properties and print quality. The control unit maintains optimal temperatures, reducing the risk of thermal-induced defects.

The term “additive manufacturing device” refers to a machine which creates objects by adding material layer by layer based on the generated toolpath. Said device comprises various types, for example fused deposition modelling, stereolithography, direct energy deposition, and powder bed fusion. The structure of said device comprises mechanisms for material deposition, layer formation, and accuracy movement. The additive manufacturing device follows the toolpath to create high-quality prints. Said device interacts with all modules to receive toolpath data and execute the printing process accordingly.

As used herein, the term “thermal imaging camera” refers to a device which captures and visualizes the thermal properties of an object or environment by detecting infrared radiation. Said device enable monitoring of temperature distributions during the additive manufacturing process. The thermal imaging camera comprises an infrared sensor, a lens to focus the infrared radiation, and a display to visualize the thermal image. The thermal imaging camera captures real-time thermal data, allowing for the identification of hot and cold spots. Said device interacts with the predictive failure detection module to provide important thermal data, enabling adjustments to the scan pattern to prevent defects caused by uneven temperature distribution.

The toolpath optimization system 100 comprises the input reception unit 102, which receives user-provided information including 3D geometric design data and material composition details of an object to be manufactured using the additive manufacturing machine. Such a unit 102 enables system 100 to accurately interpret the design and material requirements for the object to be manufactured, forming the basis for further analysis and optimization. The input reception unit 102 enables receiving and processing user-provided information, including 3D geometric design data and material composition details. The input reception unit, by receiving the three-dimensional (3D) geometric design data and material composition details, enables initialization of the manufacturing process. The detailed inputs undergo data-drive analytics approach for generating an effective toolpath, facilitating efficient layer-by-layer construction of the object. Additionally, the material composition details inform system 100 about the specific requirements and constraints associated with the materials being used, thereby influencing the toolpath and processing parameters for optimal results. The input reception unit 102 can also retrieve data from computer-aided design (CAD) tools or from external computing device, enabling seamless transfer of design specifications and material attributes from the user to the system.

The design analysis component 104, connected to the input reception unit 102, utilizes a first artificial intelligence technique to examine the user-provided information to determine an effective toolpath for manufacturing each layer of the object. Further, by determining an effective toolpath for manufacturing each layer of the object, the design analysis component 104 ensures that the toolpath is optimized for precision and efficiency. It will be appreciated that by determining an effective toolpath for manufacturing each layer of the object, the design analysis component 104 enables the toolpath to be optimized for precision and efficiency. Also, by analyzing the 3D geometric data and material details, the design analysis component 104 enables that each layer is constructed with high precision, contributing to the overall accuracy and quality of the final object. The use of AI in this context allows for responsive and intelligent decision-making, enhancing the efficiency and reliability of the toolpath planning process. The design analysis component 104 identifies the most efficient and effective toolpath for each layer, considering factors for example material behavior, geometric complexity, and layer interactions. The AI-driven analysis approach of design analysis component 104 enables generation of the toolpath, which is optimized for accuracy and efficiency, reducing material wastage and improving print quality.

In an embodiment, design analysis component 104 manages pattern and sequence selection, which are based on geometry and material properties, incorporating layer-specific and subsequent layer optimization. The design analysis component 104 utilizes AI algorithms to analyze the geometry and material properties of each layer to select the most suitable pattern and sequence for deposition. The most suitable pattern and sequence includes various shapes and sequences such as line, point, and wavy patterns. By customizing the toolpath for both individual layers and subsequent layers, the design analysis component 104 optimizes heat distribution and structural integrity throughout the entire build. The approach considers the unique characteristics of each layer and the interdependencies between layers, resulting in enhanced overall performance.

The monitoring unit 106 monitors quality control metrics of each layer and current manufacturing conditions. Such a unit 106 ensures that each layer meets the required quality standards and adapts to any changes in manufacturing conditions. Moreover, by maintaining a high level of quality control, monitoring unit 106 contributes to the overall reliability and effectiveness of the toolpath optimization system 100. The monitoring unit 106 enables continuous oversight of the manufacturing process. Monitoring unit 106 monitors quality control metrics of each layer and current manufacturing conditions ensures continuous oversight of the additive manufacturing process. This real-time monitoring enables the detection of deviations from the expected quality standards and immediate identification of adverse manufacturing conditions. Such a monitoring unit 106 ensures that each layer meets the required quality standards and adapts to any changes in manufacturing conditions. The data collected by the monitoring unit 106 serves as a critical feedback mechanism, informing the toolpath optimization unit 112 about the actual state of the manufacturing process, thus enabling prompt and informed adjustments to maintain desired quality levels. Further, by maintaining a high level of quality control, the monitoring unit 106 contributes to the overall reliability and effectiveness of the toolpath optimization system 100.

The machine learning analysis unit 108 accesses a historical database 110 comprising multiple prestored 3D shapes of multiple articles. Also, each 3D shape is indexed individually with optimal toolpath settings, substance details, recorded printing parameters, identified defects and modifications executed to the optimized toolpath settings to resolve the identified defects. It will be appreciated that by utilizing such historical data, the machine learning analysis unit 108 creates AI models predicting and optimizing toolpath strategies. The historical database 110, containing multiple prestored 3D shapes of multiple articles, provides information that is indexed with optimal toolpath settings, substance details, recorded printing parameters, identified defects and modifications executed to resolve such defects. It will be appreciated that by utilizing the historical data, the machine learning analysis unit 108 creates AI models that are essential for predicting and optimizing toolpath strategies. Further, by generating one or more AI models from database, the machine learning analysis unit 108 can predict and adapt to various manufacturing scenarios, drawing on past experiences to enhance current operations. The ability of the machine learning analysis unit 108 to leverage past data for future optimizations significantly enhances the performance of the system 100.

The toolpath optimization unit 112 utilizes the generated AI models to process the monitored quality control metrics and current manufacturing conditions to identify one or more flaws and determine a toolpath optimization strategy to mitigate each identified flaw. Further, by determining a toolpath optimization strategy to mitigate each identified flaw, the toolpath optimization unit 112 ensures that the manufacturing process remains efficient and effective. Toolpath optimization unit 112, utilizing the generated AI models, processes the monitored quality control metrics and current manufacturing conditions to identify one or more flaws. The toolpath optimization unit 112 utilizes the AI models generated by the machine learning analysis unit 108 to process the monitored quality control metrics and current manufacturing conditions. Further, by identifying flaws in real-time, the toolpath optimization unit 112 can determine a toolpath optimization strategy that addresses these issues promptly. Such a dynamic adaptation/responsiveness enables that any deviations from the optimal manufacturing conditions are corrected during manufacturing process, thereby maintaining the integrity and quality of the produced object. Moreover, by determining a toolpath optimization strategy to mitigate each identified flaw, the toolpath optimization unit 112 enables that the manufacturing process remains efficient and effective. The dynamic approach of the toolpath optimization unit 112 to optimization allows for real-time adjustments that improve the overall quality of the manufactured object.

In an embodiment, the toolpath optimization unit 112 utilizes an AI technique to identify flaws based on data from previous layers and current printing conditions and adjusts the scan pattern to mitigate failures. The toolpath optimization unit 112 continuously analyses data collected during the printing process to detect signs of issues. By using historical and real-time data, the toolpath optimization unit 112 anticipates possible failures for example layer delamination or inconsistent material deposition. Upon identifying a failure, the toolpath optimization unit 112 adjusts the scan pattern to address and mitigate the issue, thereby preventing defects and enabling the continuity of the printing process.

The control unit 114 dynamically regulates the additive manufacturing machine based on the determined toolpath optimization strategy. Additionally, by implementing the optimized strategies, the control unit 114 facilitates the production of high-quality objects and enhances the adaptability/responsiveness of the system 100 to changing conditions. The control unit 114, which dynamically regulates the additive manufacturing machine based on the determined toolpath optimization strategy, enables that the machine operates according to the optimized toolpath. Also, by implementing the optimized strategies, control unit 114 facilitates the production of high-quality objects and enhances the responsiveness of the system 100 to changing conditions. Such regulation of the manufacturing process is crucial for maintaining consistency and precision in the final product.

In an embodiment, control unit 114 dynamically adjusts one or more toolpath parameters to enable heat distribution throughout the printing process to prevent the formation of a hot spot or a cold spot. The control unit 114 monitors and controls the thermal conditions during manufacturing, enabling even heat distribution across the object. By adjusting parameters for example print speed, layer height, and extrusion temperature, the module maintains optimal thermal conditions, preventing thermal-induced defects for example warping or material inconsistency. The control unit 114 manages thermal gradients which occur during additive manufacturing, enabling the object which maintains uniform material properties. Under exemplary conditions, control unit 114 enables real-time adjustments to maintain thermal balance.

The control unit 114 dynamically adjusts the scan pattern and sequence based on real-time feedback generated from monitoring unit 106. The control unit 114 considers geometric complexity and material properties to accommodate different pattern types and sequences of each layer. The responsive capability enhances the precision and quality of the final printed parts, contributing to improved manufacturing efficiency and part reliability.

Management of thermal gradient through tool path optimization in additive manufacturing can be achieved by control unit 114. The term “thermal gradients” as used throughout the present disclosure relates to the variation in temperature that occurs over a specific distance within a material. Thermal gradients arise when there is a difference in temperature between two or more points, resulting in the flow of heat from regions of higher temperature to regions of lower temperature. Thermal gradients can lead to the formation of hot and cold spots, impacting the quality and performance of the final product. The control unit 114 dynamically adjusts one or more tool path parameters to enable heat distribution throughout the printing process, thereby preventing the formation of hot and cold spots. Control unit 114 monitors and controls the thermal conditions during manufacturing, ensuring even heat distribution across the object. By adjusting parameters, for example, print speed, layer height, and extrusion temperature, the module maintains optimal thermal conditions, thus preventing thermal-induced defects, for example, warping or material inconsistency. Hot spots in additive manufacturing are observed where the material temperature exceeds the optimal range, causing issues such as excessive melting, structural weakness, and warping. Cold spots are regions where the temperature falls below the required level, resulting in insufficient melting, poor layer adhesion, and material inconsistency. Both phenomena can significantly impact the quality and integrity of the manufactured object. As the control unit prevents formation of hot spots, control unit 114 prevent loss of dimensional accuracy and structural failures due to weakened mechanical properties. Further control unit prevent warping (i.e., uneven material contraction due to non-regular or uneven cooling) by preventing formation of hot spots. Further, control unit 114 optimize toolpath to prevent formation of cold spots to prevent formation of weak points within the printed object to enhance durability and performance of object. For example, during the printing of a complex geometry, the control unit 114 can adjust the print speed dynamically. By slowing down the print speed in areas prone to hot spots, the control unit 114 enables adequate cooling time for the material, preventing overheating. Conversely, in regions where cold spots are likely to occur, the control unit 114 can increase the print speed, ensuring sufficient heat is generated to maintain the optimal material temperature. Furthermore, control unit 114 adjusts layer height to manage thermal gradients. For instance, by reducing the layer height in sections susceptible to cold spots, the control unit 114 enables each layer to receive adequate heat, promoting proper fusion with the previous layer. Extrusion temperature is also controlled by unit 114 to maintain uniform thermal conditions. For example, during the printing of a thick section of the object, the control unit 114 can lower the extrusion temperature to prevent hot spots from forming due to the higher thermal mass of the material. Conversely, when printing thin sections, the control unit 114 can increase the extrusion temperature such that the material remains within the optimal temperature range, preventing cold spots.

Such a toolpath optimization system 100 enables the efficient and accurate fabrication of objects using additive manufacturing by dynamically adjusting the toolpath based on real-time data and historical knowledge, thereby enhancing the quality and reliability of the manufactured objects. The toolpath optimization system 100 further comprises several components that work together to optimize the additive manufacturing process by analyzing user-provided data, monitoring manufacturing conditions, utilizing machine learning models and dynamically regulating the machine.

In an embodiment, system 100 comprises an input reception unit 102. The input reception unit 102 comprises a data interface port to connect with external CAD tools. The data interface port facilitates direct import of the 3D geometric design data and material composition details from the external CAD tools into system 100. The data interface port enables seamless integration with external CAD tools, enhancing the efficiency and accuracy of data transfer. The direct import capability reduces the potential for data corruption or loss during manual transfers and ensures the integrity and accuracy of the imported data. Further, by seamlessly integrating with external CAD tools, the data interface port enhances the efficiency of the design-to-production workflow, allowing for rapid and precise initialization of the manufacturing process.

In another embodiment, the monitoring unit 106 comprises a high-resolution camera array to capture detailed images of each layer and the high-resolution camera array is connected to the control unit 114 for real-time analysis of the quality control metrics using the captured images. The high-resolution camera array enables precise monitoring of each layer, ensuring that any defects or irregularities are promptly detected. Moreover, by connecting to control unit 114 for real-time analysis, the system can promptly detect and address any anomalies or defects, ensuring consistent quality throughout the manufacturing process. The real-time analysis capability of the control unit 114 enhances the ability of the system 100 to maintain high-quality production standards.

In another embodiment, monitoring unit 106 comprises multiple environmental sensors to measure the current manufacturing conditions. The current manufacturing conditions comprise temperature, humidity and vibration. The environmental sensors are networked to provide comprehensive data for analysis. The multiple environmental sensors enable detailed monitoring of the manufacturing environment, ensuring that conditions remain optimal for producing high-quality objects. Such environmental sensors, networked to offer a holistic view of the manufacturing environment, enable the system 100 to account for and adapt to variations that could affect the quality of the printed layers. The comprehensive data provided by the networked sensors enhances the ability of the system 100 to adjust and maintain suitable manufacturing conditions.

In another embodiment, the high-resolution camera array comprises a thermal imaging camera to capture temperature distribution data across each layer and the thermal imaging camera is mounted on an adjustable arm. The thermal imaging camera enables the detection of temperature variations across each layer, which is critical for ensuring uniformity and quality in the manufactured object. Further, mounted on an adjustable arm, the thermal imaging camera can be positioned optimally for thorough inspection of each layer. The adjustable arm enhances the ability of the thermal imaging camera to capture precise thermal data from various angles and positions. This capability allows for precise thermal analysis, which is crucial for detecting and correcting thermal-related defects, such as warping or uneven cooling, thereby improving the overall quality and structural integrity of the manufactured object.

In an embodiment, the toolpath optimization unit 112 includes an actuator mechanism to implement the toolpath optimization strategy. The actuator mechanism is connected to control unit 114 for real-time adjustments to the manufacturing process. The actuator mechanism enables precise adjustments to the toolpath in response to detected flaws, ensuring continuous optimization and quality control during the manufacturing process. The ability to perform real-time adjustments enhances the responsiveness of the system 100 to detected flaws or changing manufacturing conditions, thereby maintaining the desired quality and precision of the produced layers. The connection to control unit 114 allows for immediate implementation of optimization strategies, enhancing the overall efficiency of the system 100.

In an embodiment, system 100 comprises a multi-axis motion control unit to regulate movements of the additive manufacturing machine. The multi-axis motion control unit is connected to the control unit 114 and the control unit 114 synchronizes the multi-axis motion control unit with the toolpath optimization unit 112 to ensure precise execution of the optimized toolpath. The multi-axis motion control unit enables complex and precise movements of the manufacturing machine, allowing for the creation of intricate and high-quality objects. Such synchronization is crucial for achieving high precision in the layer-by-layer construction process, reducing the likelihood of errors and enhancing the overall fidelity of the manufactured object. The synchronization with the toolpath optimization unit 112 ensures that the optimized toolpath is accurately followed.

In another embodiment, monitoring unit 106 comprises a laser scanner to measure the surface topography of each printed layer. The laser scanner is mounted on a motorized track. The laser scanner enables precise measurement of the surface topography, ensuring that each layer is correctly formed, and any deviations are promptly detected. Also, mounted on a motorized track, the laser scanner can move precisely to scan different areas of the printed layer, ensuring comprehensive topographical analysis. The motorized track enhances the ability of the scanner to cover the entire surface of each layer, providing comprehensive topographical data. Such capability is vital for identifying surface defects or irregularities early in the manufacturing process, allowing for timely corrections and ensuring the smooth and accurate construction of subsequent layers.

In an embodiment, the toolpath optimization unit 112 comprises a calibration arrangement to adjust the manufacturing based on the identified flaws. The calibration arrangement is connected to control unit 114 for automated fine-tuning of the additive manufacturing machine. The calibration arrangement enables precise adjustments to the manufacturing process in response to detected flaws, ensuring that each layer is produced to the highest quality standards. Connected to the control unit, the calibration mechanism enables automated fine-tuning of the additive manufacturing machine, maintaining high precision and quality. The automated fine-tuning capability of control unit 114 enhances the ability of the system 100 to maintain consistent quality throughout the manufacturing process.

In an embodiment, control unit 114 manages thermal gradients by controlling the heat source (e.g., laser), which melts the material at selective areas during the additive manufacturing process. The control unit 114 dynamically adjusts the laser parameters to enable even heat distribution and prevent the formation of hot and cold spots. By modulating the laser power, scanning speed, and scanning pattern, control unit 114 maintains optimal thermal conditions throughout the printing process, thus enhancing the quality and consistency of the final product. For instance, during the fabrication of a part with varying cross-sectional areas, the control unit 114 can adjust the laser power to prevent the formation of hot spots in regions with thicker cross-sections. For example, printing a thick-walled section of a component, control unit 114 may lower the laser power from 100 watts to 80 watts to reduce the energy input, thereby allowing the material to cool slightly and avoid excessive melting. Such adjustment allows for proper melting and solidification of the material, ensuring dimensional accuracy and structural integrity. In regions with lower thermal mass or thinner cross-sections, insufficient heat input can lead to cold spots. Control unit 114 increases the laser power in these areas to ensure adequate melting. For example, during printing a thin-walled section, control unit 114 may increase the laser power from 80 watts to 120 watts, ensuring the material reaches the necessary melting temperature for proper layer adhesion. Optionally, control unit 114 also manages the scanning speed of the laser to control thermal gradients. For example, when printing a section prone to hot spots, control unit 114 increases the scanning speed, reducing the exposure time of the material to the laser. This adjustment minimizes heat accumulation, preventing overheating. In contrast, for sections where cold spots are likely to occur, control unit 114 decreases the scanning speed, allowing more time for the material to absorb heat and reach the necessary melting temperature.

In another embodiment, control unit 114 can optimize scanning pattern to manage thermal gradients. For instance, a zigzag or spiral scanning pattern can distribute heat more evenly across the part compared to a linear pattern. By selecting an appropriate scanning pattern, control unit 114 enables uniform heat distribution, minimizing the risk of hot and cold spots.

In an embodiment, the control unit 114 utilize AI based data analytics approach to adjust laser power to manage thermal gradients during the additive manufacturing process to enable optimal heat distribution across the material, preventing hot and cold spots. The control unit utilizes machine learning based techniques to analyze data from previous printing processes, including temperature profiles, laser power settings, scanning speeds, material properties, and resulting thermal gradients. The collected historiological data is used to train machine learning models to predict the optimal laser settings and toolpath modifications required for different sections of the part being printed. The models learn to identify patterns and correlations between the input parameters and the resulting thermal conditions, enabling accurate predictions for future prints.

During the printing process, control unit 114 continuously monitors the temperature of the material in real-time using sensors of the monitoring unit. The control unit utilizes AI algorithms to analyze real-time data to detect any deviations from the desired thermal profile. When a potential hot spot is detected, the AI-based analysis predicts the necessary reduction in laser power and modification of the toolpath to prevent overheating. The control unit 114 then adjusts the laser power and modifies the toolpath accordingly to enable that temperature remains within optimal range. Similarly, when a cold spot is detected, the AI-based analysis determines the appropriate increase in laser power and adjustment of the toolpath to enable sufficient heat input. Control unit 114 implements such adjustments, enabling the material to reach the necessary melting temperature for proper layer adhesion and fusion. These adjustments are made dynamically and in real-time, allowing for continuous optimization of the thermal conditions and toolpath throughout the printing process. The continuous feedback loop between the real-time temperature data, AI-based analysis, and laser power adjustments enables precise control over the thermal conditions. As the printing process progresses, the machine learning models continuously update and refine their predictions based on updated data, improving the accuracy of the laser power adjustments over time. Such a responsive approach enables that the thermal gradients effectively managed.

Thus, control unit 114, through AI-based analysis, adjusts laser power dynamically and in real-time to manage thermal gradients during additive manufacturing. By leveraging machine learning algorithms, the control unit 114 predicts optimal laser power settings and makes continuous adjustments based on real-time temperature data, preventing hot and cold spots and enhancing the quality and consistency of the final product.

In an embodiment, the control unit 114 performs data cleaning to remove noise from the collected data by the monitoring unit 106 to improve accuracy and reliability of the information used in the additive manufacturing process. Data noise, such as outliers and irrelevant information, can significantly affect the performance of machine learning models. Control unit 114 employs various algorithms to identify and eliminate these discrepancies from the dataset. For instance, control unit 114 might use filtering techniques to smooth out erratic data points and remove anomalies that do not conform to expected patterns. By cleaning the data, control unit 114 enables that the subsequent analysis is based on accurate and high-quality information, leading to better predictions and more precise adjustments toolpath selection and toolpath parameter optimization.

In another embodiment, the machine learning analysis unit 108 conducts normalization to improve consistency across the dataset used for training and real-time adjustments. Normalization involves scaling the data to a standard range, to eliminate the impact of differing units and scales. Normalization enables the machine learning models to interpret and compare data accurately, enhancing predictive capabilities thereof. For example, temperature readings, laser power levels, and print speeds are normalized to common scale (e.g., SI Unit) such that the machine learning algorithms can effectively identify patterns and relationships. By normalizing the data, machine learning analysis unit 108 enables that the models perform optimally, leading to achieve control over thermal gradients and improved toolpath optimization.

In yet another embodiment, the user (e.g., machine operator) provides annotation/labeling data corresponds to identified defects and quality markers within data of database. For example, user examines printed parts to detect issues such as warping, delamination, or material inconsistencies, labeling these defects accordingly. The control unit 114 utilizes labeled data to re-train/update machine learning models to improve accuracy. By utilizing expert knowledge, control unit 114 improves the precision and reliability of AI-based analysis, leading to better control over thermal gradients and higher quality outcomes in additive manufacturing. Alternatively, control unit 114 can utilize automated labeling, facilitated by AI-assisted algorithms, by rapidly annotating large volumes of data. Machine learning analysis unit 108 employs various labelling algorithms to identify and label defects and quality markers in the data collected during the additive manufacturing process. Automated labeling reduces the workload on human experts and allows for real-time data annotation for toolpath optimization. By integrating AI-assisted labeling, machine learning analysis unit 108 enhances the efficiency and accuracy of defect detection and quality control, leading to better management of thermal gradients and improved product quality. Verification involves manual checks to ensure the accuracy of the data labeled by both manual and automated processes.

In another embodiment, control unit 114 performs validation to validate the correctness of the annotations such that the machine learning models are trained on reliable data. Experts (e.g., materials scientist, additive manufacturing engineer, CAD designer, operator/technician) can review a sample of the labeled data to confirm that defects and quality markers have been correctly identified and categorized. Validation can enable identification and rectification of any errors or inconsistencies in the labeling.

In an embodiment, the control unit 114 employs AI based image analysis algorithms to optimize the additive manufacturing process by managing thermal gradients and enhancing overall print quality. The machine learning model performs heatmap images analysis to extract relevant features. Based on the extracted features, control unit 114 performs real-time adjustments to laser parameters and toolpaths, to achieve uniform heat distribution and preventing the formation of hot and cold spots. The AI based image analysis comprises segmentation of complex heatmaps images generated during the printing process. The AI based image analysis can identify regions of varying temperature, classifying them as hot spots, cold spots, or areas with optimal thermal conditions. By segmenting these images, AI based image analysis provides detailed information about the thermal state of the printed object, enabling control unit 114 to make required adjustments. Optionally, the AI based image analysis involves sequential data (e.g., progression of temperature changes over time) analysis to understand how thermal gradients evolve throughout the printing process. By utilizing AI based image analysis, control unit 114 can predict future thermal states based on current and past data, enabling proactive adjustments. Based on understanding of thermal dynamics, control unit 114 dynamically modifies printing conditions, enhancing layer adhesion, surface finish, and geometric accuracy.

In another embodiment, control unit 114 utilizes feature extraction techniques to identify and analyze various features of the additive manufacturing process from heatmap images. The features selected from hot and cold spots, layer adhesion quality, surface finish/morphology, and geometric accuracy. By extracting such features, control unit 114 can adopt data-driven adjustments to optimize printing parameters.

In an embodiment, the control unit 114 generates performance reports that provide valuable insights into the quality, efficiency, and post-processing suggestions of the additive manufacturing process. The report provide insight about overall performance of the additive manufacturing machine and identifying areas for improvement. The report may also comprise information regarding bottlenecks or inefficiencies in the process. For instance, if the print speed is slower than expected, the performance report will highlight this issue, allowing the manufacturer to investigate the cause and make necessary adjustments. Additionally, the report may provide insights into material usage, indicating areas where material wastage can be minimized. Further, report may also comprise one or more post-processing suggestions. For example, if the report identifies surface roughness as a quality issue, control unit 114 may suggest additional finishing processes, such as sanding or polishing, to achieve the desired surface smoothness. Similarly, if there are any dimensional inaccuracies, the report may recommend post-processing techniques, such as machining or heat treatment, to achieve precise dimensions.

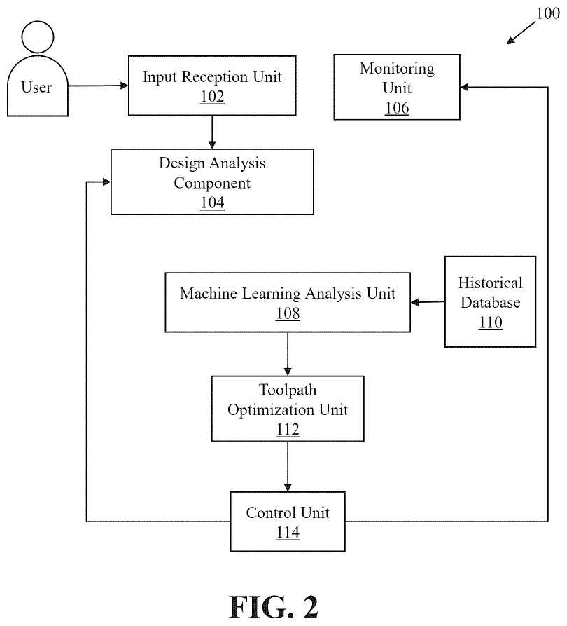

Referring to FIG. 2, there is shown a block diagram of system 100 of FIG. 1, in accordance with an embodiment of the present disclosure. System 100 comprises an input reception unit 102 that receives user-provided information, including three-dimensional (3D) geometric design data and material composition details. The design analysis component 104, connected to the input reception unit 102, utilizes a first artificial intelligence technique to determine an effective toolpath for manufacturing each layer of the object. The monitoring unit 106 monitors quality control metrics of each layer and current manufacturing conditions. The machine learning analysis unit 108 accesses a historical database 110 containing multiple prestored 3D shapes of various articles, each indexed with optimal toolpath settings, substance details, recorded printing parameters, identified defects and modifications to resolve such defects. The machine learning analysis unit 108 generates one or more artificial intelligence models. Toolpath optimization unit 112 processes the monitored quality control metrics and current manufacturing conditions using the generated AI models to identify flaws and determine a toolpath optimization strategy. The control unit 114 dynamically regulates the additive manufacturing machine based on the determined toolpath optimization strategy. Such a system 100 enables efficient and precise fabrication by dynamically adjusting the toolpath in real-time, leveraging historical data to optimize manufacturing processes and ensuring high-quality output through continuous monitoring and responsive control.

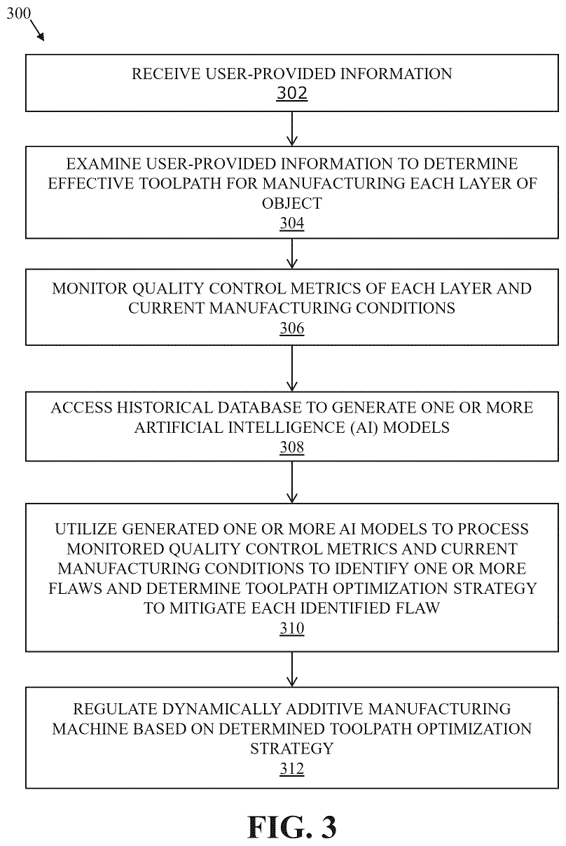

Referring to FIG. 3, there is shown a flowchart 300 of a method of optimizing toolpath for an additive manufacturing machine, in accordance with an embodiment of the present disclosure. At step 302, user-provided information is received. The user-provided information comprises three dimensional (3D) geometric design data of an object to be manufactured using the additive manufacturing machine and material composition details. At step 304, the user-provided information is examined to determine an effective toolpath for manufacturing each layer of the object. At step 306, quality control metrics of each layer and current manufacturing conditions are monitored. At step 308, a historical database is accessed to generate one or more artificial intelligence (AI) models. The historical database comprises multiple prestored 3D shapes of multiple articles and wherein each 3D shape is indexed, individually, with each of optimal toolpath settings, substance details, recorded printing parameters, identified defect and modification executed to the optimized toolpath settings to resolve the identified defect. At a step 310, the generated one or more AI models are utilized to process the monitored quality control metrics and the current manufacturing conditions to identify one or more flaws and determine a toolpath optimization strategy to mitigate each identified flaw. At step 312, the additive manufacturing machine is dynamically regulated based on the determined toolpath optimization strategy.

In an embodiment, the method comprises capturing detailed images of each layer and performing real-time analysis of the quality control metrics using the captured images.

In an embodiment, the current manufacturing conditions comprise temperature, humidity and vibration.

In an embodiment, the method comprises capturing temperature distribution data across each layer.

In an embodiment, the method comprises measuring surface topography of each printed layer.

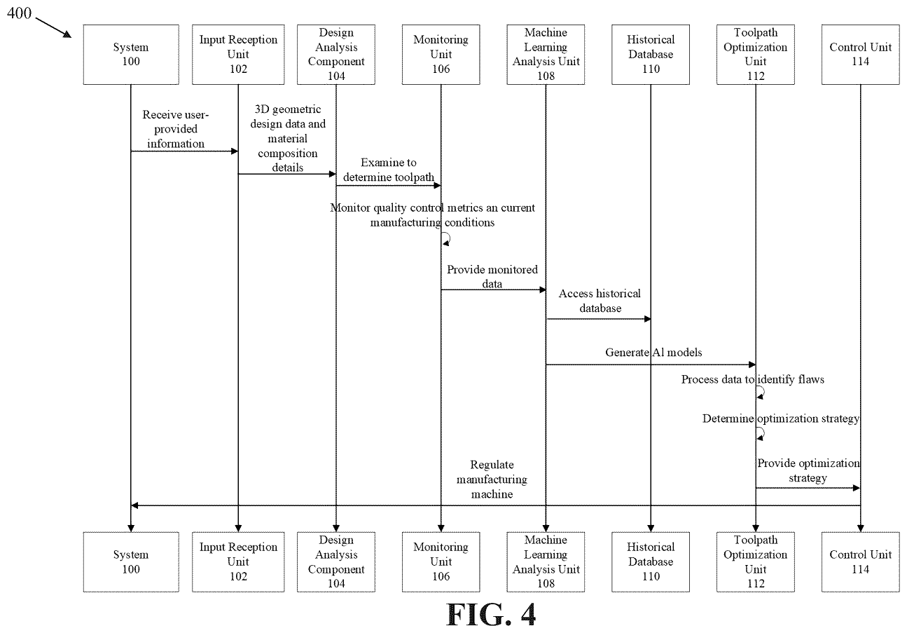

Referring to FIG. 4, there is shown a sequence diagram of the method of optimizing toolpath of FIG. 3, in accordance with an embodiment of the present disclosure. The method comprises receiving user-provided information, including three-dimensional (3D) geometric design data and material composition details of an object to be manufactured using the additive manufacturing machine. The user-provided information is examined to determine an effective toolpath for manufacturing each layer of the object. Further, quality control metrics of each layer and current manufacturing conditions are monitored continuously. Also, a historical database, containing multiple prestored 3D shapes of various articles indexed with optimal toolpath settings, substance details, recorded printing parameters, identified defects and modifications to resolve such defects, is accessed to generate one or more artificial intelligence (AI) models. The generated AI models are utilized to process the monitored quality control metrics and current manufacturing conditions to identify one or more flaws and determine a toolpath optimization strategy to mitigate each identified flaw. The additive manufacturing machine is dynamically regulated based on the determined toolpath optimization strategy. Such a method enables precise and efficient fabrication by dynamically adjusting the toolpath in real-time, leveraging historical data for optimization, and ensuring high-quality output through continuous monitoring and responsive control.

Further disclosed is a computer program product for optimizing toolpath for an additive manufacturing machine, the computer program product comprising a non-transitory computer-readable medium having program instructions stored thereon, the program instructions, when executed by one or more processors, cause the one or more processors to perform a method comprising receiving user-provided information. The user-provided information comprises three dimensional (3D) geometric design data of an object to be manufactured using the additive manufacturing machine and material composition details. The method further comprises examining the user-provided information to determine an effective toolpath for manufacturing each layer of the object, monitoring quality control metrics of each layer and current manufacturing conditions and accessing a historical database to generate one or more artificial intelligence (AI) models. The historical database comprises multiple prestored 3D shapes of multiple articles. Further, each 3D shape is indexed, individually, with each of optimal toolpath settings, substance details, recorded printing parameters, identified defect and modification executed to the optimized toolpath settings to resolve the identified defect. Moreover, the method comprises utilizing the generated one or more AI models to process the monitored quality control metrics and the current manufacturing conditions to identify one or more flaws and determine a toolpath optimization strategy to mitigate each identified flaw and dynamically regulating the additive manufacturing machine based on the determined toolpath optimization strategy.

Example embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including hardware, software, firmware, and a combination thereof. For example, in one embodiment, each block of the block diagrams and flowchart illustrations, and combinations of blocks in the block diagrams and flowchart illustrations can be implemented by computer program instructions. These computer program instructions may be loaded onto a general-purpose computer, special purpose computer, or other programmable data processing apparatus to produce a machine, such that the instructions which execute on the computer or other programmable data processing apparatus create means for implementing the functions specified in the flowchart block or blocks.

Throughout the present disclosure, the term ‘processing means’ or ‘microprocessor’ or ‘processor’ or ‘processors’ or ‘control unit’ includes, but is not limited to, a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

The term “non-transitory storage device” or “storage” or “memory,” as used herein relates to a random-access memory, read only memory and variants thereof, in which a computer can store data or software for any duration.

Operations in accordance with a variety of aspects of the disclosure described above would not have to be performed in the precise order described. Rather, various steps can be handled in reverse order or simultaneously or not at all.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

Throughout the present disclosure, the term ‘Artificial intelligence (AI)’ as used herein relates to any mechanism or computationally intelligent system that combines knowledge, techniques, and methodologies for controlling a bot or other element within a computing environment. Furthermore, the artificial intelligence (AI) is configured to apply knowledge and that can adapt it-self and learn to do better in changing environments. Additionally, employing any computationally intelligent technique, artificial intelligence (AI) is operable to adapt to unknown or changing environment for better performance. Artificial intelligence (AI) includes fuzzy logic engines, decision-making engines, preset targeting accuracy levels, and/or programmatically intelligent software.

I/We claim:

1. A toolpath optimization system for an additive manufacturing machine, wherein the system comprises:
an input reception unit to receive user-provided information, wherein the user-provided information comprises:
three dimensional (3D) geometric design data of an object to be manufactured using the additive manufacturing machine; and
the material composition details;
a design analysis component connected to the input reception unit, wherein the design analysis component utilizes a first artificial intelligence technique to examine the user-provided information to determine an effective toolpath for manufacturing each layer of the object;
a monitoring unit monitors:
the quality control metrics of each layer; and
the current manufacturing conditions;
a machine learning analysis unit accesses a historical database to generate one or more artificial intelligence (AI) models, wherein the historical database comprises multiple prestored 3D shapes of multiple articles and wherein each 3D shape is indexed, individually, with each of: optimal toolpath settings, substance details, recorded printing parameters, identified defect and modification executed to the optimized toolpath settings to resolve the identified defect;
a toolpath optimization unit utilizes the generated one or more AI models to process the monitored quality control metrics and the current manufacturing conditions to identify one or more flaws and determine a toolpath optimization strategy to mitigate each identified flaw; and
a control unit dynamically regulates the additive manufacturing machine based on the determined toolpath optimization strategy.

2. The system as claimed in claim 1, wherein the input reception unit comprises a data interface port to connect with external CAD tools and wherein the data interface port facilitates direct import of the 3D geometric design data and material composition details from the external CAD tools into the system.

3. The system as claimed in claim 1, wherein the monitoring unit comprises a high-resolution camera array to capture detailed images of each layer and wherein the high-resolution camera array is connected to the control unit for real-time analysis of the quality control metrics using the captured images.

4. The system as claimed in claim 3, wherein the monitoring unit comprises multiple environmental sensors to measure the current manufacturing conditions, wherein the current manufacturing conditions comprise: temperature, humidity and vibration and wherein the environmental sensors are networked to provide comprehensive data for analysis.

5. The system as claimed in claim 3, wherein the high-resolution camera array comprises a thermal imaging camera to capture temperature distribution data across each layer and wherein the thermal imaging camera is mounted on an adjustable arm.

6. The system as claimed in claim 1, wherein the toolpath optimization unit includes an actuator mechanism to implement the toolpath optimization strategy and wherein the actuator mechanism is connected to the control unit for real-time adjustments to the manufacturing.

7. The system as claimed in claim 1, wherein the system comprises a multi-axis motion control unit to regulate movements of the additive manufacturing machine, wherein the multi-axis motion control unit is connected to the control unit and wherein the control unit synchronizes the multi-axis motion control unit with the toolpath optimization unit to ensure precise execution of the optimized toolpath.

8. The system as claimed in claim 1, wherein the monitoring unit comprises a laser scanner to measure surface topography of each printed layer and wherein the laser scanner is mounted on a motorized track.

9. The system as claimed in claim 1, wherein the toolpath optimization unit comprises a calibration arrangement to adjust the manufacturing based on the identified flaws and wherein the calibration mechanism is connected to the control unit for automated fine-tuning of the additive manufacturing machine.

10. A method of optimizing toolpath for an additive manufacturing machine, wherein the method comprises:
receiving user-provided information, wherein the user-provided information comprises:
three dimensional (3D) geometric design data of an object to be manufactured using the additive manufacturing machine; and
material composition details;
examining the user-provided information to determine an effective toolpath for manufacturing each layer of the object;
monitoring quality control metrics of each layer and current manufacturing conditions;
accessing a historical database to generate one or more artificial intelligence (AI) models, wherein the historical database comprises multiple prestored 3D shapes of multiple articles and wherein each 3D shape is indexed, individually, with each of: optimal toolpath settings, substance details, recorded printing parameters, identified defect and modification executed to the optimized toolpath settings to resolve the identified defect;
utilizing the generated one or more AI models to process the monitored quality control metrics and the current manufacturing conditions to identify one or more flaws and determine a toolpath optimization strategy to mitigate each identified flaw; and
regulating, dynamically, the additive manufacturing machine based on the determined toolpath optimization strategy.

11. The method as claimed in claim 10, wherein the method comprises:
capturing detailed images of each layer; and
performing real-time analysis of the quality control metrics using the captured images.

12. The method as claimed in claim 10, wherein the current manufacturing conditions comprise: temperature, humidity and vibration.

13. The method as claimed in claim 10, wherein the method comprises capturing temperature distribution data across each layer.

14. The method as claimed in claim 10, wherein the method comprises measuring surface topography of each printed layer.

15. A computer program product for optimizing toolpath for an additive manufacturing machine, the computer program product comprising a non-transitory computer-readable medium having program instructions stored thereon, the program instructions, when executed by one or more processors, cause the one or more processors to perform a method comprising:
receiving user-provided information, wherein the user-provided information comprises:
three dimensional (3D) geometric design data of an object to be manufactured using the additive manufacturing machine; and
material composition details;
examining the user-provided information to determine an effective toolpath for manufacturing each layer of the object;
monitoring quality control metrics of each layer and current manufacturing conditions;
accessing a historical database to generate one or more artificial intelligence (AI) models, wherein the historical database comprises multiple prestored 3D shapes of multiple articles and wherein each 3D shape is indexed, individually, with each of: optimal toolpath settings, substance details, recorded printing parameters, identified defect and modification executed to the optimized toolpath settings to resolve the identified defect;
utilizing the generated one or more AI models to process the monitored quality control metrics and the current manufacturing conditions to identify one or more flaws and determine a toolpath optimization strategy to mitigate each identified flaw; and
regulating, dynamically, the additive manufacturing machine based on the determined toolpath optimization strategy.
